(19) United States
(12) Patent Application Publication
(10) Pub. No.: US 2004/0151204 A1
(43) Pub. Date: Aug. 5, 2004

(54) Communication device and communication method

(75) Inventors: Masashi Eguchi, Joyo-shi (JP); Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/758,394

(22) Filed: Jan. 16, 2004

(30) Foreign Application Priority Data
Jan. 30, 2003 (JP) 2003-021502

(51) Int. Cl. H04J 3/16

(52) U.S. Cl. 370/465

(57) ABSTRACT

When receiving a transmission request that designates a user as a destination, a control unit of a communication device inquires a remote server via a communication unit. The remote server looks up data, and returns a communication destination device that manages the user of the destination and communication information for communicating with the communication destination device. The control unit of the communication device receives the reply, specifies a communication channel or a communication protocol in accordance with the communication information to the communication destination device through the communication unit and transmits the information to the user within a range of receiving ability. When transmitting the information, a cover page can be formed from the information of the user of the destination, and the cover page can be attached to the information and transmitted.

### BACKGROUND OF THE INVENTION

1. Field of the Invention

The present invention relates to a communication device and a communication method which carries out communication through a network.

2. Description of Related Art

Accompanying recent developments in communication devices which are provided with multi-functions, communication ability of each of the communication devices is becoming different from one another. As a result, even when the same information is transmitted to different communication devices, there are cases where one communication device can receive the information but a different communication device fails to receive the information. In addition, a communication channel and a communication protocol used for communicating with a communication device of a destination are also becoming diverse. Therefore, before carrying out a communication, a user is required to designate each time, the receiving ability of the communication device of the destination, the communication channel to be used, and the communication protocol or the like.

For example, there is a communication device which fetches ability information of a communication device of a destination from a server, and transmits the information in accordance with the ability information. As a result, the information can be transmitted according to the receiving ability of the communication device of the destination automatically without the user being conscious of the receiving ability of the communication device of the destination.

Meanwhile, in a general communication device such as a conventional facsimile machine or the above-described communication device, the communication is generally carried out by designating the communication device of the destination. For example, even in case one communication device is used by a plural number of users, when transmitting information addressed to a specific user, the communication was carried out by designating the communication device, and not by designating the user. For example, when carrying out facsimile transmission, the communication was carried out by designating a telephone number or the like of a facsimile machine used by the user of the destination. Therefore, a user at a transmitting side was required to know in advance which communication device the user of the destination was using. In addition, when carrying out the communication, the user at the transmitting side was required to designate the communication device used by the user of the destination and then to carry out the communication.

When using electronic mail that is recently being used frequently for communication, the communication is carried out by designating the user. However, electronic mail can use only Simple Mail Transfer Protocol/Post Office Protocol (SMTP/POP) as the communication protocol. Therefore, the information cannot be transmitted to a communication device that uses a communication protocol other than the SMTP/POP.

### SUMMARY OF THE INVENTION

An advantage of the present invention is to provide a communication device which can use a plurality of communication channels and communication protocols, and more particularly, a communication device which specifies a communication destination device by designating a user and which can communicate with the specified communication destination device.

According to a first aspect of the present invention, the communication device includes a communication unit which can communicate by a plurality of communication channels and communication protocols, and a control unit. In accordance with information that specifies a user designated as a destination, the control unit specifies a communication destination device that manages the user. In addition, the control unit obtains communication information that is necessary for communicating with the communication destination device, and communicates with the communication destination device via the communication unit by following the communication information. Accordingly, even when a user is designated as the destination, the communication destination device can be specified automatically, the communication information that is necessary for communicating with the communication destination device (for example, the communication channel, the communication protocol, and the receiving ability) can be obtained and the communication can be carried out. Therefore, the user at the transmitting side can communicate with the communication destination device, which is used by the user of the destination, just by designating the user of the destination.

According to a second aspect of the present invention, the communication destination device that manages the user of the destination and the communication information of the communication destination device can be obtained from a remote server via the communication unit.

According to a third aspect of the present invention, since the user of the destination is designated at transmission, a cover page can be formed in accordance with the information that specifies the user of the destination, and the cover page can be transmitted to the communication destination device along with the information that is to be transmitted.

### BRIEF DESCRIPTION OF DRAWINGS

FIG. 1 is a block diagram showing an example of a system including a communication device according to an embodiment of the present invention.

FIG. 2 shows an example of a management table.

FIG. 3 is a flowchart showing an example of an operation carried out at transmission by the communication device according to an embodiment of the present invention.

FIG. 4 is a block diagram showing another example of a system including the communication device according to an embodiment of the present invention.

FIG. 5 shows an example of a table which stores information regarding a server that manages terminals.

### DETAILED DESCRIPTION OF PREFERRED EMBODIMENTS

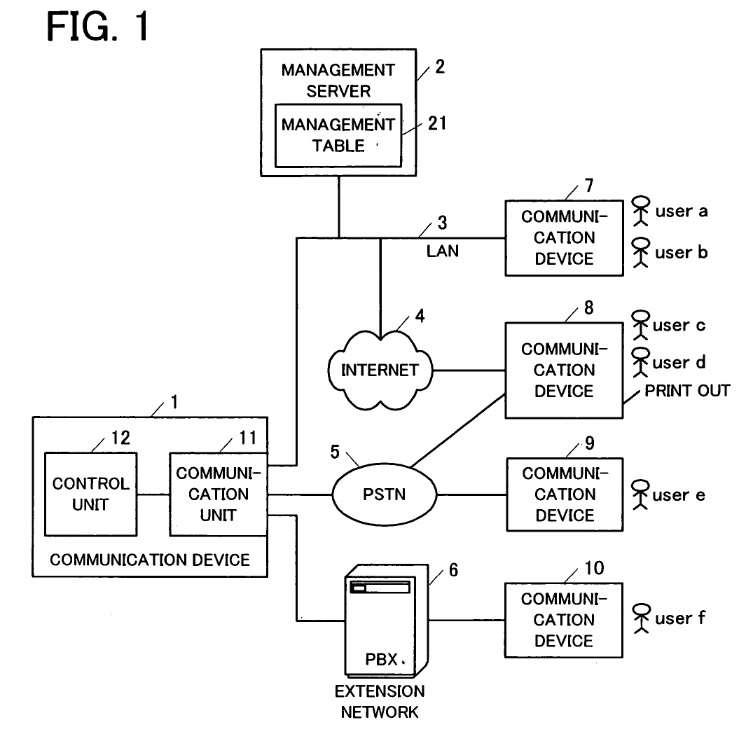

FIG. 1 is a block diagram showing an example of a system including a communication device according to an embodiment of the present invention. In FIG. 1, reference numeral 1 denotes a communication device, 2 a management server, 3 a Local Area Network (LAN), 4 the Internet, 5 a Public Switched Telephone Network (PSTN), 6 an extension network, 7 through 10 communication devices, 11 a communication unit, 12 a control unit, and 21 a management table. The communication device 1 is an example of a communication device according to the present invention. In this example, the communication device 1 can carry out communication using the LAN 3, the Internet 4, the PSTN 5 and the extension network 6 as communication channels. Further, in this example, the communication device 1 uses the Internet 4 via the LAN 3. The communication unit 11 of the communication device 1 can carry out communication by using the communication channels in accordance with the control of the control unit 12. Of course, the present invention is not limited to the configuration of the system shown in FIG. 1.

The control unit 12 of the communication device 1 carries out control to transmit information via the communication unit 11 in accordance with an instruction from an operation unit (not shown) or a transmission request received via the communication unit 11 or the like. In this case, as a destination of the transmission of the information, a designation is accepted by information that specifies a user such as a user name or a user ID. Then, in accordance with the accepted information that specifies the user of the destination, the control unit 12 inquires the management server 2 through the communication unit 11, and specifies a communication device that manages the user. In addition, the control unit 12 obtains the communication information that is necessary for communicating with the specified communication device (for example, the communication channel, the communication protocol and the receiving ability). Then, in accordance with the obtained communication information, the control unit 12 transmits the information through the communication unit 11 to the specified communication device with the user accepted as the destination. In this case, in accordance with the information that specifies the user of the destination, a cover page can be formed, and the cover page can be transmitted along with the information to be transmitted.

The management server 2 stores and manages as a management table 21, information regarding the communication devices 7 through 10 (the communication device 1 can be included). Further, the information includes information regarding a user managed by each of the communication devices and communication information of each of the communication devices. According to an inquiry from a remote device, the management server 2 returns all of the information or a part of the information looked up.

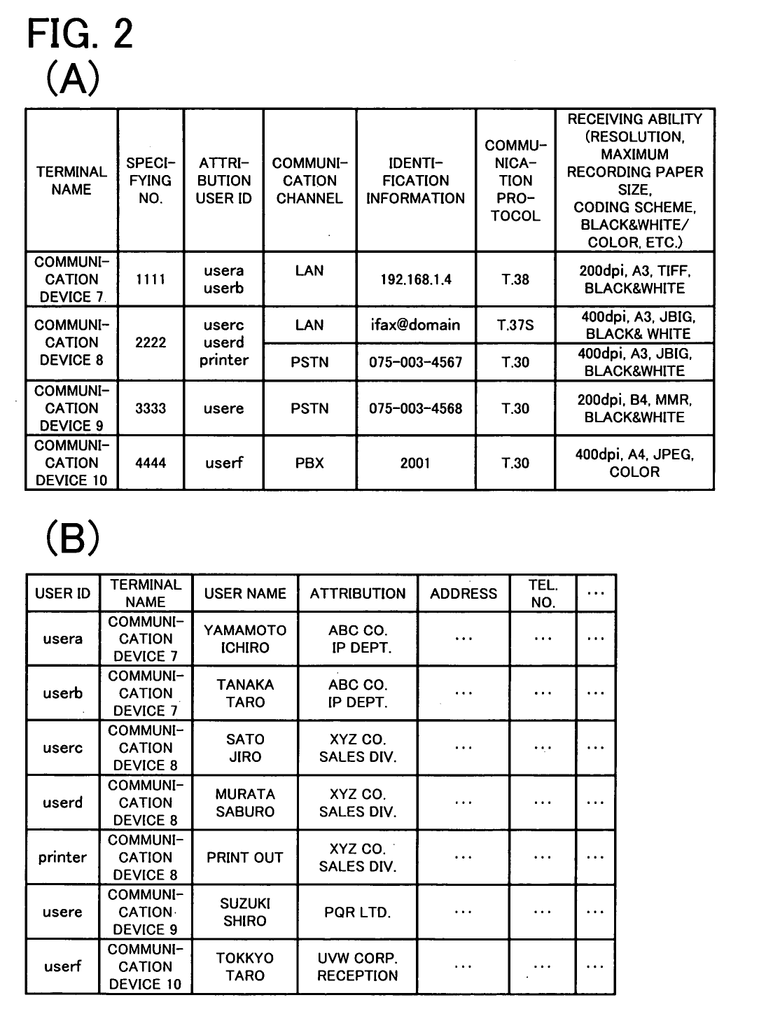

FIG. 2 shows an example of the management table 21. In the example shown in FIG. 2, the management table 21 consists of two tables. In the table shown in FIG. 2(A), the information for each of the communication devices is registered. In this example, the information such as a terminal name, a specifying number, an attribution user ID, and communication information or the like are registered. The terminal name and the specifying number are the information for uniquely specifying the communication device in the system, and the table may include only either one of the terminal name or the specifying number. The attribution user ID stores an ID of the user managed by the communication device. In this example, an ID is applied to each of the users respectively, and the users are managed by the ID. However, other information such as a user name can be used for managing the user if the user can be identified uniquely in the system. Moreover, in this example, the communication information includes information such as a communication channel, identification information, a communication protocol, and receiving ability or the like.

In the example shown in FIG. 1, the LAN 3, the Internet 4 (in FIG. 2, shown as the LAN), the PSTN 5 and the extension network 6 can be used for the communication channel. The identification information is information that specifies the communication device when using each of the communication channels. For example, when using the LAN 3, an Internet Protocol (IP) address is designated, when using the Internet, an electronic mail address or a Uniform Resource Locator (URL) is designated, when using the PSTN 5, a telephone number is designated, and when using the extension network 6, an extension number is designated. The communication protocol shows the communication protocol used when using each of the communication channels. Furthermore, the receiving ability may include various pieces of information such as resolution, maximum recording paper size, coding scheme, and distinction between color and black and white.

In the table shown in FIG. 2(B), information for each of the users is registered. As described above, an ID is applied to each of the users, and the user ID, a terminal name which is a name of the communication device that manages the user, a user name corresponding to the user ID, and other information (for example, attribution, address, and telephone number) are registered. Further, the user ID may be assigned to only the users, or as shown in FIG. 2(B) by “printer”, the user ID may be applied to a part of functions of the communication device or an apparatus connected to the communication device and the management can be carried out.

By using such a table, for example, the table shown in FIG. 2(B) can be looked up from the user ID (or the user name) and the communication device that manages the user can be specified. Furthermore, by looking up the table shown in FIG. 2(A) from the specified communication device, the communication information can be obtained. Further, by using only the table shown in FIG. 2(A), the communication device that manages the user and the communication information of the communication device can be obtained by looking up the user ID.

In the example shown in FIG. 2, the communication device 8 can carry out communication by using a plurality of communication channels. In such a case, for example, it can be defined to use one of the communication channels normally and to use another communication channel when the communication channel used normally cannot be used. Alternatively, the communication channel that is easy to use for the communication device can be selected at the communication device side.

Further, the management table 21 can be stored by the management server 2 or can be stored and managed by each of the communication devices. In this case, when there is an addition or an omission of a communication device or when the information is updated, the change is handled by each of the communication devices. In such a case, by distributing the updated information of the management table 21 to each of the communication devices, the management table 21 can be updated easily.

In the example shown in FIG. 1, the management server 2 is connected to the same LAN 3 as the communication device 1. However, the present invention is not limited to this example. The management server 2 may be located on the Internet 4, or can be accessed through the PSTN 5 or the extension network 6.

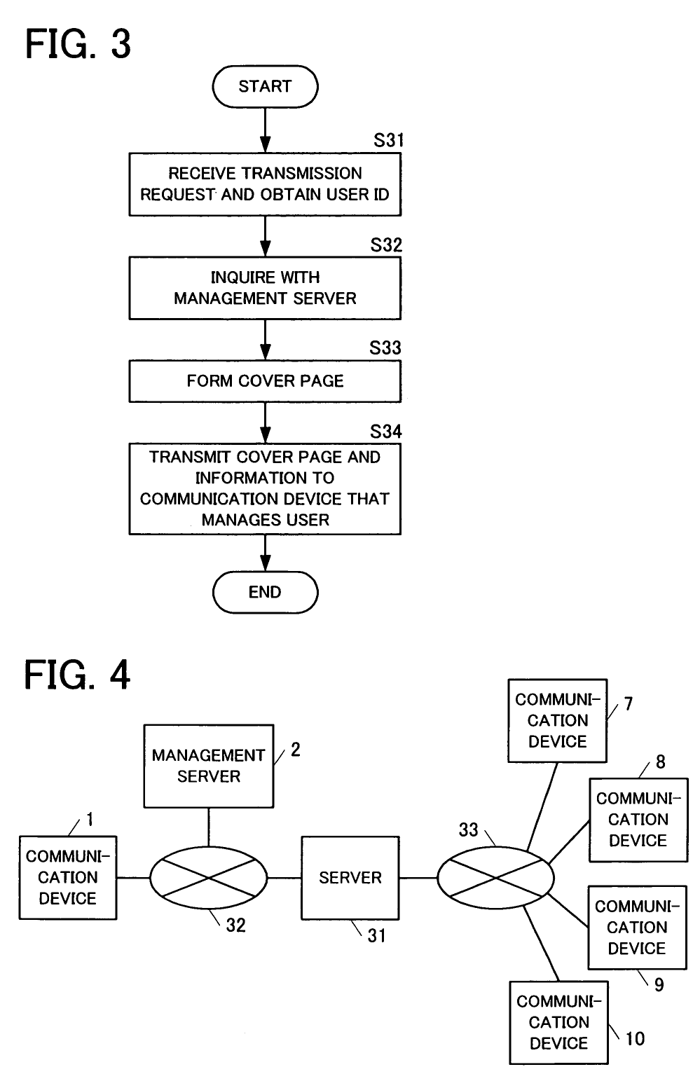

FIG. 3 is a flowchart showing an example of an operation carried out at transmission by the communication device according to an embodiment of the present invention. First, in step S31, when receiving a request of transmission, the information that specifies the user designated as the destination is obtained from the request. As an example, it is supposed here that the user ID is obtained.

Next, in step S32, the management server 2 is inquired in accordance with the user ID obtained in step S31. The management server 2 stores the management table 21 (an example is shown in FIG. 2). For example, from the table shown in FIG. 2(B), it is possible to know which communication device is managing the user of the inquired user ID. The communication information of the communication device can be obtained from the table shown in FIG. 2(A). The management server 2 returns to the communication device 1 that made the inquiry, the information of the communication devices and the communication information of the communication devices.

In step S33, the communication device 1 can form a cover page in accordance with the information that specifies the user obtained in step S31 (and the information of the transmitter). For example, when obtaining the information from the management server 2 in step S32, if the user information shown in FIG. 2(B) is also obtained, the user name, the attribution or the like of the destination can be inserted automatically to the cover page. Further, the information of the transmitter can be inserted in the template of the cover page in advance, or the communication device 1 can be holding the transmitter information, or the transmitter information can be obtained from the management server 2 or another server that manages the transmitter information. Of course, the cover page may or may not be formed, and this determination can be made selectable.

In step S34, the information that has been requested to be transmitted and the cover page formed in step S33 are transmitted to the communication device that manages the user of the destination obtained by inquiring with the management server 2 in step S32. In this case, in accordance with the communication information of the communication device received from the management server 2 in step S32, the information can be converted according to the receiving ability of the communication device, or the communication channel and the communication protocol to be used for the communication can be selected, and the communication can be carried out.

Accordingly, in accordance with the transmission request which the user is designated as the destination, the information can be transmitted to the communication device that manages the user. Moreover, it is not necessary to know in advance about the communication channel, the communication protocol or the receiving ability of the communication device of the destination of the information to be transmitted. The communication information can be obtained automatically from the management server 2, and in accordance with the communication information, the information can be transmitted.

Further, when a certain communication channel cannot be used, or when the communication is carried out once or a plurality of times by using a certain communication channel but the information fails to be transmitted normally, the communication can be carried out by using a bypass. For example, when transmitting the information to a user c in FIG. 1, the communication device 8 is selected as the destination. The communication device 8 can carry out the communication by using the Internet 4 and the PSTN 5. In such a case, for example, the information is normally transmitted by using the Internet, and when the Internet 4 becomes unusable, the communication can be carried out by using the PSTN 5 as the bypass.

For the information regarding the bypass, for example, the information for a plurality of communication channels can be obtained when inquiring with the management server 2, and a communication channel can be selected from the plurality of communication channels and the selected communication channel can be used as the bypass. Alternatively, the management server 2 can be inquired as to the bypass information, and communication information that is different from the communication information obtained previously can be obtained from the management server 2.

In the same manner, when the same user is managed by different communication devices, in case the information fails to be transmitted normally to a certain communication device that manages the user, the information can be transmitted to another communication device that manages the same user. In this case, a plurality of communication devices and the communication information can be obtained by inquiring with the management server 2, and a communication device can be selected from the plurality of the communication devices. Alternatively, when the information fails to be transmitted normally, the management server 2 can be inquired as to an alternative communication device. The alternative communication device cannot be selected in conventional communication where the communication is carried out by designating a communication device.

FIG. 4 is a block diagram showing another example of a system including a communication device according to an embodiment of the present invention. In FIG. 4, the same reference numerals are applied to parts that are the same as the parts of FIG. 1, and description will be omitted. Reference numeral 31 denotes a server, and 32 and 33 denote networks. Further, in FIG. 4, the LAN 3, the Internet 4, the PSTN 5 and the extension network 6 or the like in FIG. 1 are collectively shown by the networks 32 and 33. Of course, the networks 32 and 33 can be the same.

In the above-described example, the information addressed to the user that is managed directly by each of the communication devices is transmitted to the communication device. In the example shown in FIG. 4, one or a plurality of communication devices managing each of the users are managed by different network apparatus. In the example shown in FIG. 4, the communication devices 7 through 10 are managed by the server 31, and each of the communication devices 7 through 10 manages the user respectively as in FIG. 1. For example, the communication devices 7 through 10 are client terminals in an office, and the server 31 is provided to control over the client terminals and to receive information from a remote device.

In such a case, the communication device 1 inquires with the management server 2 and obtains a fact that the server 2 is managing the user of the destination and the communication information of the server 2 as the result. In accordance with the obtained information, the communication device 1 designates the user of the destination and transmits the information (and the cover page) to the server 2.

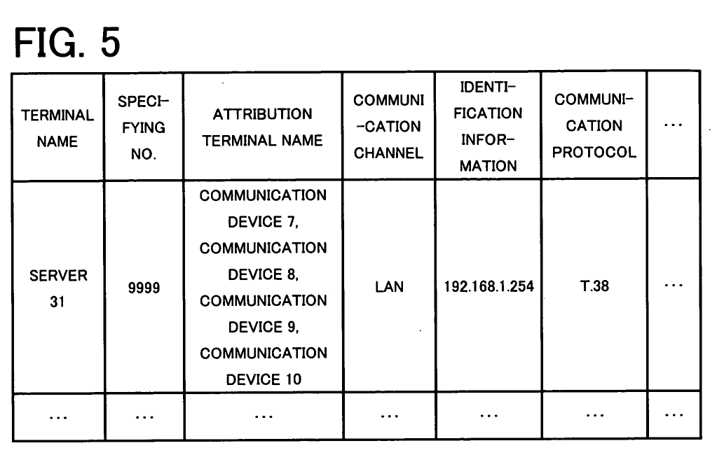

As the management table 21, the management server 2 stores the table shown in FIG. 2 and a table for specifying the server that is managing the communication devices 7 through 10. FIG. 5 shows an example of a table which stores information regarding a server that manages a terminal. For example, as shown in FIG. 5, the management server 2 can manage a table which associates a server name (or information that specifies the server such as a server ID) and a terminal name (the communication device) managed by the server. By using the table of FIG. 5 along with the two tables of FIG. 2, a communication device that manages the user can be determined from the user ID and the server that manages the communication device can be determined. Then, the determined server and the communication information for communicating with the server can be returned to the communication device that made the inquiry.

The server 31 that received the information from the communication device 1 can forward the received information to the communication device that manages the user of the destination. In this case, as described in FIG. 1, an inquiry can be made again to the management server 2 or another management server, and the communication device that manages the user of the destination can be specified and the communication information for communicating with the communication device can be obtained.

As described above, the information that designates the user as the destination can be transmitted even via the server 31. When forwarding the information via the server 31, the server 31 functions as a relay terminal. In this case, the network 32 and the network 33 can be different kinds of communication channels. By using the server 31, for example, even when transmitting the information to the user managed by the communication device to which the communication cannot be carried out directly from the communication device 1, the communication can be carried out between the communication devices by relaying the communication by the server 31.

Further, information can be forwarded to a communication device that manages the user of the destination via more than one server. Moreover, for example, when the communication cannot be carried out directly to the selected server due to a failure or the like, it can be configured so that an alternative server is selected.

What is claimed is:

1. A communication device comprising:
a communication unit which can carry out communication by a plurality of communication channels and communication protocols; and
a control unit which specifies a communication destination device managed by a user in accordance with information that specifies the user designated as a destination, obtains communication information necessary for communicating with the communication destination device, and carries out the communication with the communication destination device via the communication unit in accordance with the communication information.

2. The communication device according to claim 1, wherein the control unit obtains the information that specifies the communication destination device and the communication information from a remote server via the communication unit.

3. The communication device according to claim 2, wherein the communication information is information regarding a communication channel between the communication device and the communication destination device.

4. The communication device according to claim 2, wherein the communication information is identification information of the communication destination device.

5. The communication device according to claim 2, wherein the communication information is information regarding a communication protocol of the communication destination device.

6. The communication device according to claim 2, wherein the communication information is information regarding a receiving ability of the communication destination device.

7. The communication device according to claim 1, wherein the control unit forms cover page information in accordance with the information that specifies the user, and transmits the cover page information to the communication destination device.

8. A communication device comprising:
means for communicating by a plurality of communication channels and communication protocols; and
means for specifying a communication destination device managed by a user in accordance with information that specifies the user designated as a destination, obtaining communication information necessary for communicating with the communication destination device, and communicating with the communication destination device via the means for communicating in accordance with the communication information.

9. The communication device according to claim 8, further comprising:
means for obtaining the information that specifies the communication destination device and the communication information from a remote server via the means for communicating.

10. The communication device according to claim 8, further comprising:
means for forming cover page information in accordance with the information that specifies the user; and
means for transmitting the cover page information to the communication destination device.

11. The communication device according to claim 8, further comprising:
means for extracting information regarding another communication channel from the communication information when failing to communicate with the communication destination device; and
means for retransmitting the information to the communication destination device via the another communication channel.

12. The communication device according to claim 8, further comprising:
means for obtaining communication information regarding another communication channel from a remote server when failing to communicate with the communication destination device; and
means for communicating again with the communication destination device via the another communication channel in accordance with the obtained communication information.

13. The communication device according to claim 8, further comprising:
means for determining whether or not the communication is carried out with the communication destination device;
means for specifying another communication destination device when the communication fails to be carried out;
means for extracting communication information regarding another communication destination device in accordance with the obtained communication information; and
means for communicating again with the another communication destination device in accordance with the extracted communication information.

14. The communication device according to claim 8, further comprising:
means for determining whether or not the communication is carried out with the communication destination device;
means for obtaining another communication destination device and communication information of the another communication destination device from a remote server when the communication fails to be carried out; and
means for communicating again with the another communication destination device in accordance with the obtained communication information.

15. A communication method comprising the steps of:
obtaining identification information of a communication destination device in accordance with information that specifies a user;
obtaining communication information of the communication destination device from a management server in accordance with the identification information of the communication destination device; and
communicating with the communication destination device in accordance with the obtained communication information.

16. The communication method according to claim 15, further comprising the steps of:
forming cover page information in accordance with the obtained identification information of the communication destination information; and
transmitting the cover page information to the communication destination device.

17. The communication method according to claim 15, further comprising the steps of:
determining whether or not the information is communicated with the communication destination device; and
communicating with the communication destination device by another communication channel in accordance with the obtained communication information when failing to communicate the information.

18. The communication method according to claim 15, further comprising the steps of:
determining whether or not the communication is carried out with the communication destination device;
obtaining communication information regarding another communication channel from a remote server when failing to transmit the information; and
communicating with the communication destination device via the another communication channel in accordance with the obtained communication information.

19. The communication method according to claim 15, further comprising the steps of:
determining whether or not the communication is carried out with the communication destination device;
specifying another communication destination device in accordance with the obtained identification information;
extracting communication information regarding the another communication destination device in accordance with the obtained communication information; and
communicating again with the another communication destination device in accordance with the extracted communication information.

20. The communication method according to claim 15, further comprising the steps of:
determining whether or not the communication is carried out with the communication destination device;
obtaining another communication destination device and communication information of the another communication destination device from a remote server when failing to transmit; and
communicating again with the another communication destination device in accordance with the obtained communication information.
